(19) United States
(12) Patent Application Publication
(10) Pub. No.: US 2026/0197310 A1
(43) Pub. Date: Jul. 9, 2026

(54) PASSKEY AFFILIATION SCORE-BASED AUTHENTICATION AND RISK ASSESSMENT

(71) Applicant: Wells Fargo Bank, N.A., San Francisco, CA (US)

(72) Inventors: John Andrew Chuprevich, Davidson, NC (US); Miles Anthony Melvin, Huntersville, NC (US); Angela M. Sicord, San Francisco, CA (US); Brad A. Stinson, JR., Cramerton, NC (US); Matthew N. Wheeler, Charlotte, NC (US)

(21) Appl. No.: 19/009,710

(22) Filed: Jan. 3, 2025

(51) Int. Cl. H04L 9/40

(52) U.S. Cl. CPC H04L 63/083; H04L 63/0428

(57) ABSTRACT

Systems and techniques may be used for authentication or risk assessment based on a passkey affiliation score. An example technique may include querying a user device for a passkey keychain, receiving the passkey keychain, the passkey keychain including at least one passkey between a user-affiliated entity and the user device, and sending a verification request to the user-affiliated entity. The example technique may include receiving a verification response from the user-affiliated entity indicating whether the identity and the at least one passkey are valid and match, and generating a passkey affiliation score for the user device in response to receiving the verification response.

### BACKGROUND

Individuals often possess multiple digital identities across various online platforms. While these identities provide valuable information about users, they remain largely isolated from each other or disconnected from real-world identities. This fragmentation poses challenges for authentication or trust establishment, particularly in scenarios where a user interacts with a

new or unfamiliar entity. Traditional authentication methods, such as passwords or knowledge-based questions, can be susceptible to breaches and may not provide a comprehensive picture of trustworthiness.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram showing components of a passkey-based authentication

system, according to various examples.

FIG. 2 illustrates trusted entities of a user device and an onboarding entity, according to various examples.

FIG. 3 illustrates a hierarchical structure of trusted entities associated with an onboarding entity, according to various examples.

FIGS. 4-6 illustrate flowcharts showing techniques for generating a passkey affiliation score, according to various examples.

FIG. 7 illustrates generally an example of a block diagram of a machine upon which any one or more of the techniques discussed herein may perform, according to various examples.

### DETAILED DESCRIPTION

The systems and techniques described herein may be used to enhance authentication or trust establishment in digital interactions. An example technique may include receiving a passkey keychain from a user, the passkey keychain indicating an affiliated entity with which the user has established a passkey-based relationship. The example technique may include leveraging a passkey relationship to generate a passkey affiliation score for the user, representing an inferred level of confidence in the user's identity. The example technique may include using the passkey affiliation score to make an authentication decision, such as granting access to a service or resource. In some examples, the passkey affiliation score may be dynamically adjusted based on one or more additional factors including the strength or tenure of a passkey relationship, or external data related to the user or an affiliated entity.

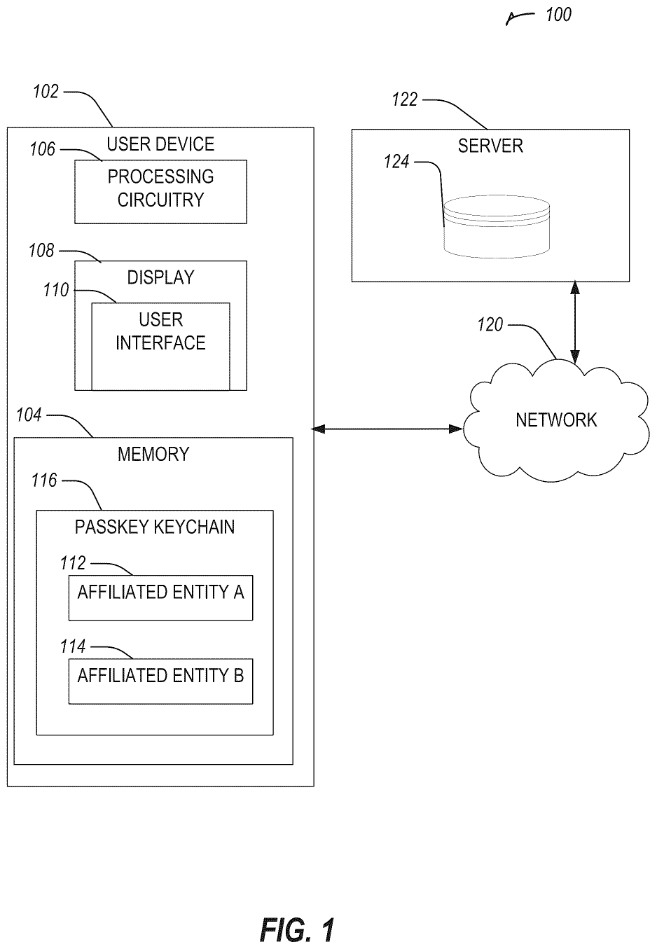

FIG. 1 illustrates a diagram showing components of a passkey-based authentication system. The system 100 includes a server 122 including a database 124 (e.g., on the server 122, remote from the server, multiple databases, etc.). The server 122 is communicatively coupled via a network 120 to a user device 102. The user device 102 comprises memory 104, processing circuitry 106, and a display 108 configured to present a user interface 110. The memory 104 may store a passkey keychain 116, such as including data related to a set of entities, such as affiliated entity data A 112 and affiliated entity data B 114.

The user device 102 may include various hardware or software components, such as those necessary or useful for a financial transaction or other online services. In some examples, the user device 102 may be a mobile phone, a tablet, a laptop, a wearable device, or another computing device capable of storing or managing passkeys. The user device 102 may interact with the user through the user interface 110 or various input/output mechanisms, such as a touchscreen, keyboard, biometric sensors, or voice commands. In some examples, the user device 102 may include a secure element or other hardware-backed storage for securely storing a private key associated with a passkey.

In some examples, the network 120 may include a wired connection, such as an Ethernet connection, or a wireless connection, such as Wi-Fi, a cellular protocol, Bluetooth, or the like. A secure communication protocol may employ encryption algorithms such as Transport Layer Security (TLS) or Secure Sockets Layer (SSL) to protect the data transmitted between the user device 102 and the server 122. In other examples, message authentication codes (MACs) or digital signatures may be used to ensure the integrity of the data.

In some examples, the server 122 may receive a passkey keychain from the user device 102, generate a passkey affiliation score for the user device 102, or provide remote access to a setting or a functionality of the user device 102. In some examples, the server 122 may be used to update the user device 102 (e.g., software, firmware, sending data for storage, etc.).

In some embodiments, the server may act as a central repository for storing or managing passkey-related information, including a user profile, affiliated entity data, or historical authentication records. In other examples, the server 122 may employ a machine learning algorithm or other analytical technique to process the received passkey keychain or generate a passkey affiliation score that reflects trustworthiness of a user. The server 122 may facilitate communication between the user device 102 and an affiliated entity during a verification process to ensure the secure exchange of data. In other examples, the server 122 may provide remote access capabilities, allowing an authorized entity to manage settings or perform an action on the user device 102, such as remotely locking the user device 102 or wiping sensitive data in case of loss or theft.

The affiliated entity data A 112 or data B 114 may be one of various entities or organizations with which the user has established a passkey-based relationship. For example, an affiliated entity may be a financial institution, a social media platform, an online retailer, an email provider, a government agency, or any other service provider that supports passkey authentication. Passkey authentication is an authentication method that may not require a password but still provides security. Passkey authentication may use public key cryptography to create a unique digital key for a user account, for example by storing a private key securely on the user device 102. An affiliated entity may be identified in the passkey keychain 116 (e.g., a unique set of passkeys stored on the user device 102) by a unique identifier, such as a domain name, a service ID, or a cryptographic hash.

In some examples, the affiliated entity data A 112 or data B 114 may represent one of a wide range of online services or platforms that the user interacts with. The unique identifier associated with an entity may be a human-readable string, such as a website or domain name, or a machine-readable code, such as a universally unique identifier (UUID) or a cryptographic hash of the entity's domain name. In an example, the passkey keychain 116 may store additional information about an affiliated entity, such as a logo, contact details, type of service, or the like.

An affiliated entity corresponding to affiliated entity data A 112 or data B 114 may be communicatively connected to the server 122 or may exchange a verification request or response with the server 122 to facilitate an authentication process. The communication with the affiliated entity may include a secure protocol or encryption to protect sensitive user data. In some examples, the communication between the server 122 and the affiliated entity may use a secure protocol like HTTPS or TLS to ensure data confidentiality or integrity. The verification request or response may be encrypted using a symmetric or asymmetric encryption algorithm, or a digital signature or message authentication code may be employed to verify the authenticity or integrity of the message. The affiliated entity may implement an access control mechanism to restrict unauthorized access to user data or ensure compliance with privacy regulations.

In some examples, a non-affiliated entity may seek to authenticate the user device 102 by leveraging a trusted relationship between the user device 102 and an affiliated entity. The non-affiliated entity may represent a new service provider, online merchant, or other organization that the user device 102 is interacting with for the first time. In some examples, the non-affiliated entity may utilize a passkey affiliation score generated by the server 122 to assess the trustworthiness of the user device 102 or make an informed decision about granting access, offering a service, setting a transaction limit, or the like. For example, an online retailer may use a passkey affiliation score to determine whether to offer the user device 102 a guest checkout option or require a user of the user device 102 to create an account. A financial institution may use the passkey affiliation score to evaluate the risk associated with a new loan application or to streamline the onboarding process for a user of the user device 102 (e.g., when the passkey affiliation score exceeds a threshold).

The non-affiliated entity may interact with the server 122 to initiate an authentication process or receive a passkey affiliation score. In other examples, the non-affiliated entity may interact with the user device 102 to initiate an authentication process or receive a passkey affiliation score. The passkey affiliation score may be used by the non-affiliated entity to make a decision about access to a service, account privilege, or the like for the user device 102. The passkey affiliation score may be generated by the server 122 or the user device 102. The passkey affiliation score may be based on one or more factors, such as a number of affiliated entities, a type of affiliated entity, a trust level of an affiliated entity, the tenure of a relationship, verification information received from the affiliated entity, or the like, such as those in the passkey keychain 116.

The passkey affiliation score may be used to determine whether to grant the user device 102 access to a particular service or resource, to evaluate a risk associated with a user device 102 transaction or activity, to specify a user experience, to offer a specific benefit to the user device, to identify potentially suspicious or fraudulent activity, or the like. For example, a passkey affiliation score above a threshold may be used to allow the user device 102 to bypass a security check or gain access to a premium feature, while a passkey affiliation score below a threshold may trigger an additional verification step or limit access to sensitive information.

In some examples, the passkey affiliation score may be used to personalize a user experience by offering a tailored recommendation, promotion, or other content based on the inferred level of trust. In the context of fraud detection, the passkey affiliation score may be combined with one or more other behavioral or transactional data checks to identify an anomaly or pattern that may indicate fraudulent activity.

The passkey-based relationship between the user device 102 and an affiliated entity may be indicated by the affiliated entity data A 112 or data B 114. For example, the user device 102 may be registered with an affiliated entity to generate a passkey, which may be securely stored on the user device 102 in the memory 104, for example in the passkey keychain 116. In an example, the user device 102 may be used to scan a QR code provided by an affiliated entity, initiating a passkey creation or exchange. In an example, the user device 102 may accept a biometric indication, which may trigger generation or storage of a passkey. The biometric verification may be performed locally on the user device 102 or remotely through a secure authentication service.

In some examples, the affiliated entity data A 112 or data B 114 may include information related to a passkey-based relationship. This information may include an identifier (e.g., of the user or the user device 102), a passkey public key, other relevant data associated with a passkey-based relationship, or the like. The server 122 may access this information during a verification process to confirm the validity of a passkey or generate a passkey affiliation score. The server 122 may use a secure communication protocol or authentication mechanism to ensure that only an authorized entity can access the stored passkey information. In some examples, the affiliated entity may periodically update the stored information to reflect a change in the relationship or account status.

The passkey keychain 116 may include an identifier for an affiliated entity in the affiliated entity data (e.g., 112 or 114), such as a domain name or unique service ID. In some examples, the passkey keychain 116 may store other relevant data associated with the passkey relationship, such as the date of establishment, the frequency of use, or a type of transaction performed. The passkey keychain 116 may include metadata associated with a passkey, such as creation date, last used timestamp, security level, or the like of the passkey.

When generating a passkey affiliation score, one or more factors may be used, such as a strength of a relationship with an affiliated entity (e.g., as indicated by one or more metrics such as the frequency or recency of passkey usage, the types of services accessed, or the volume of a transaction conducted), a duration or tenure of the passkey relationship (e.g., with a longer-standing relationship corresponding to a higher passkey affiliation score), a reputation or trustworthiness of the affiliated entity, online behavior of a user, or the like. The passkey affiliation score may be generated using data from one or more sources, such as public records, credit reports, social media activity, private user data with permission, or the like.

The passkey affiliation score may be generated using a rule-based system, a decision tree, a statistical model, a machine learning trained model (e.g., a neural network), or the like. The passkey affiliation score may be generated via a model that is updated periodically to incorporate new data, improve accuracy, or adapt to an evolving user behavior or pattern. The updating process may include refining a rule or a parameter of the model based on feedback or performance evaluation. In some examples, the generated passkey affiliation score may be used by a non-affiliated entity to make an informed decision about the trustworthiness of a user or the user device 102. For example, a financial institution may use the passkey affiliation score to determine whether to approve a loan application, while an online marketplace may use it to assess the risk of a transaction. In other examples, the passkey affiliation score may be used by the user to demonstrate the trustworthiness of a user or the user device 102 in an online interaction. The score may be presented as a numerical value, a visual representation, or the like.

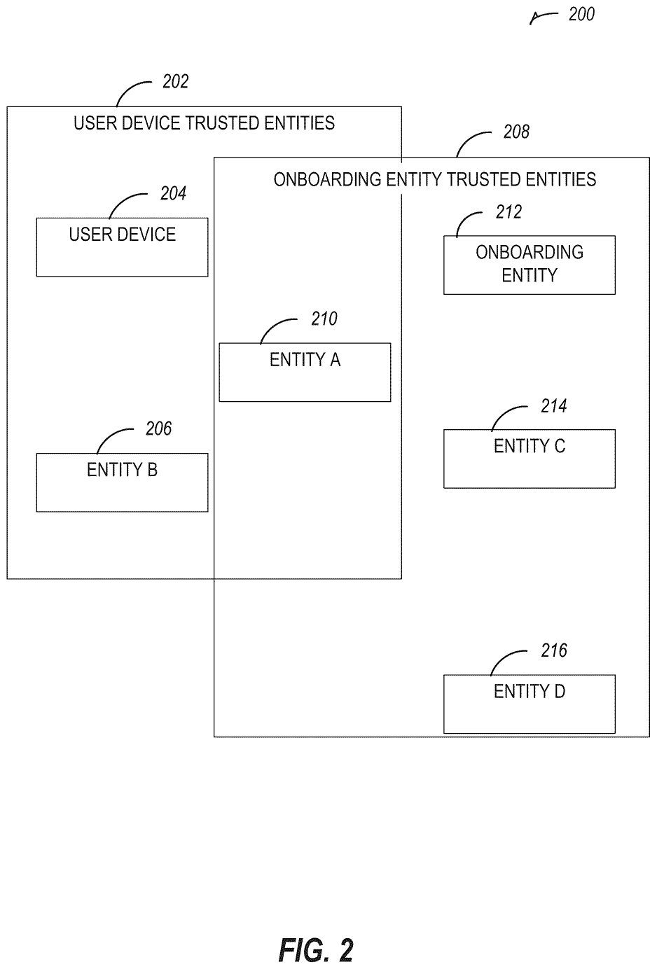

FIG. 2 illustrates a block diagram 200 showing trusted entities of a user device 204 and an onboarding entity 212, according to various examples. The block diagram 200 illustrates shared trusted entities that may be leveraged to establish trust and facilitate authentication between a user and a new service provider.

The user device trusted entities 202 may represent a collection of entities or organizations with which the user device 204 has established a trusted relationship. In some examples, these trusted entities may include a financial institution, a government agency, a service provider, a social media company, etc. In an example, entity A 210 and entity B 206 are trusted entities with which the user device 204 has established a trusted relationship.

The onboarding entity trusted entities 308 may represent a group of entities that the onboarding entity 212 considers trustworthy. In some examples, these entities may be partners, service providers the onboarding entity 212 collaborates with, regulatory bodies the onboarding entity 212 adheres to, or the like. In an example, entity A 210, entity C 214, and entity D 216 are among the entities that the onboarding entity 212 considers trustworthy.

In some examples, there may be an overlap between the two groups of trusted entities (202 and 208), such as entity A 210, which appears in both the user device trusted entities 202 and the onboarding entity trusted entities 208. This shared entity A 210 may serve as a bridge between the user device 204 and the onboarding entity 212. In an example, the onboarding entity 212 may leverage its existing trust in entity A 210 to infer a degree of trust in the user device 204, such as based on a passkey affiliation score. In some examples, the presence of a shared trust relationship may contribute to a higher score or indicate a more trustworthy user.

In some examples, the overlap may include more than one entity. For example, there may be multiple shared trust entities between the user device 204 and the onboarding entity 212. In these examples, one or more of the shared trust entities may be used to generate an overall trust assessment or a passkey affiliation score. The strength or nature of the overlapping relationship may be used to generate the passkey affiliation score, such as with more established or frequently used connections carrying greater weight. The composition of trusted entities for the user device 204 and the onboarding entity 212 may change over time. For example, a new entity may be added, an existing entity may be removed, an existing entity may have a change in trust level based on one or more factors such as user activity, entity reputation, updated data, or the like.

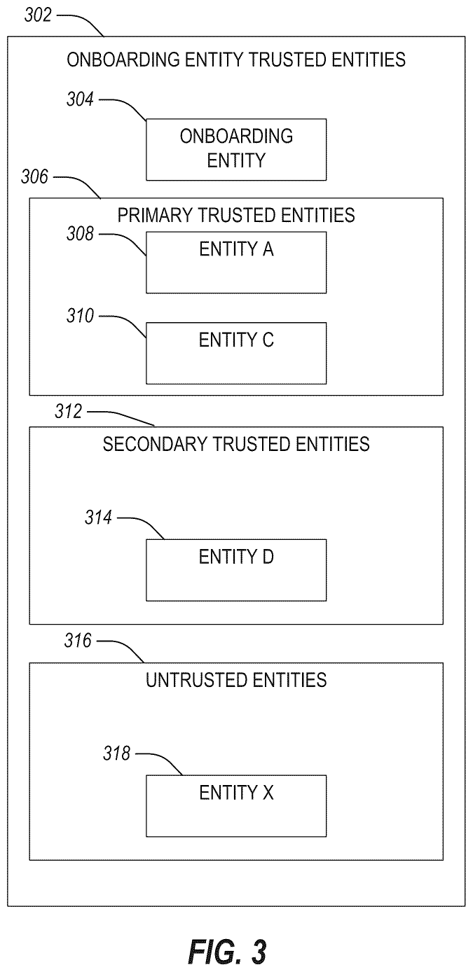

FIG. 3 illustrates a hierarchical structure of trusted entities associated with an onboarding entity 304, according to various examples. FIG. 3 illustrates a set of onboarding entity trusted entities 302 that are listed by category. Example categories shown in FIG. 3 include primary trusted entities 306, secondary trusted entities 312, and untrusted entities 316. Additional (e.g., tertiary trusted entities, conditionally trusted entities such as by region or country, according to user trusted level, or the like, etc.) or fewer categories (e.g., only the primary category and the untrusted category) may be used. In some examples, the hierarchy may reflect varying degrees of trust that the onboarding entity 304 may place in different entities, for example based on perceived reputation, security practices, potential risks, or the like of the entities. The hierarchical structure may be selected by the onboarding entity 304 or generated (e.g., according to a rule or dynamically) for example based on an industry of the onboarding entity 304, a default rule, or past behavior of the onboarding entity 304 (e.g., for similar users).

The primary trusted entities 306 may include one or more entities that are considered to be highly reliable and trustworthy by the onboarding entity 304. In an example, the primary trusted entities 306 may include a large, well-established organization with a strong track record of security and ethical practices. For example, an entity A 308 in the primary trusted entities 306 may be a government agency, a major financial institution, or a reputable healthcare provider. In some examples, an entity, such as entity C 310 in the primary trusted entities 306 may include a sibling subsidiary or parent of the onboarding entity 304. The onboarding entity 304 may have a high degree of confidence in the identity verification and authentication process performed by a primary trusted entity. In FIG. 3, the entity A 308 and the entity C 310 may be considered primary trusted entities 306.

The secondary trusted entities 312 may represent a category of entities that are considered to be generally reliable and trustworthy, but may not have the same level of established reputation or security as the primary trusted entities 306. In an example, a secondary trusted entity may be a smaller organization, a newer company, an entity operating in an industry with a moderate level of risk, or the like. For example, a secondary trusted entity may be a utility company, a subscription service provider, an online retailer, or the like. The onboarding entity 304 may have a moderate degree of confidence in the identity verification and authentication processes performed by one of the secondary trusted entities 312. In the illustrated example of FIG. 3, entity D 314 may be considered a secondary trusted entity.

The untrusted entities 316 may correspond to entities that are not trusted by the onboarding entity 304. These entities may include ones associated with a scam, fraud, past bad dealings, a history of security breaches, data misuse, or fraudulent activity. For example, entity X 318 in the untrusted entities 316 may be a company that is not trusted by the onboarding entity 304. In another example, the untrusted entity 316 may include an entity operating in a high-risk industry or one with an opaque ownership structure. For example, an untrusted entity may be an unregulated cryptocurrency exchange, an online gambling platform, a website known for spreading misinformation, or the like. In some examples, the onboarding entity 304 may exercise caution when interacting with an untrusted entity 316 and may require additional verification steps or impose stricter access controls. In some examples, a user with an entity in the untrusted entities 316 in a passkey chain may have a lower passkey affiliation score than a user without the untrusted entity. In the illustrated example of FIG. 3, the entity X 318 may be considered an untrusted entity.

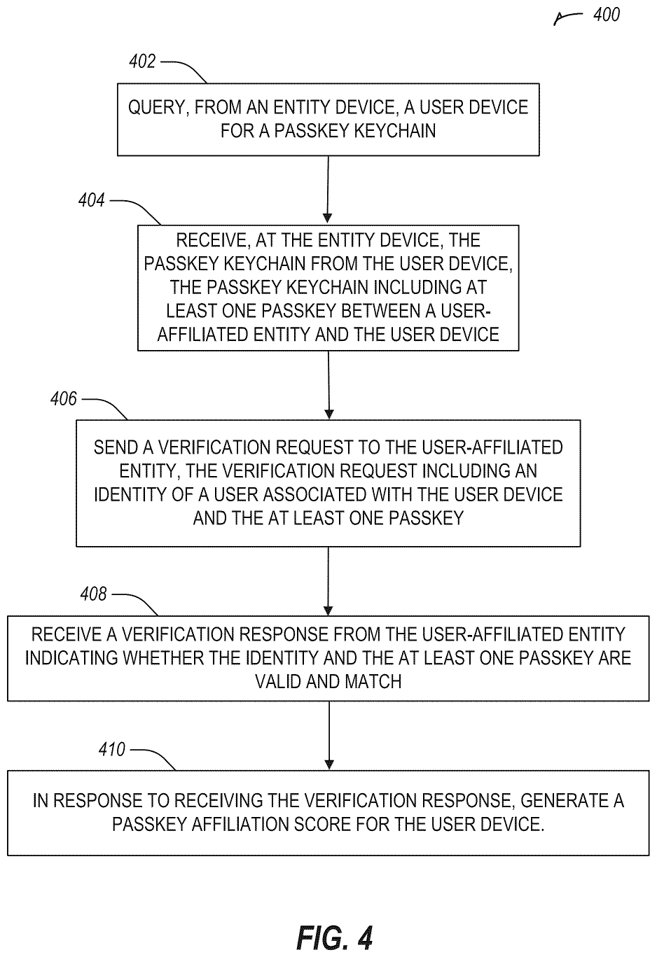

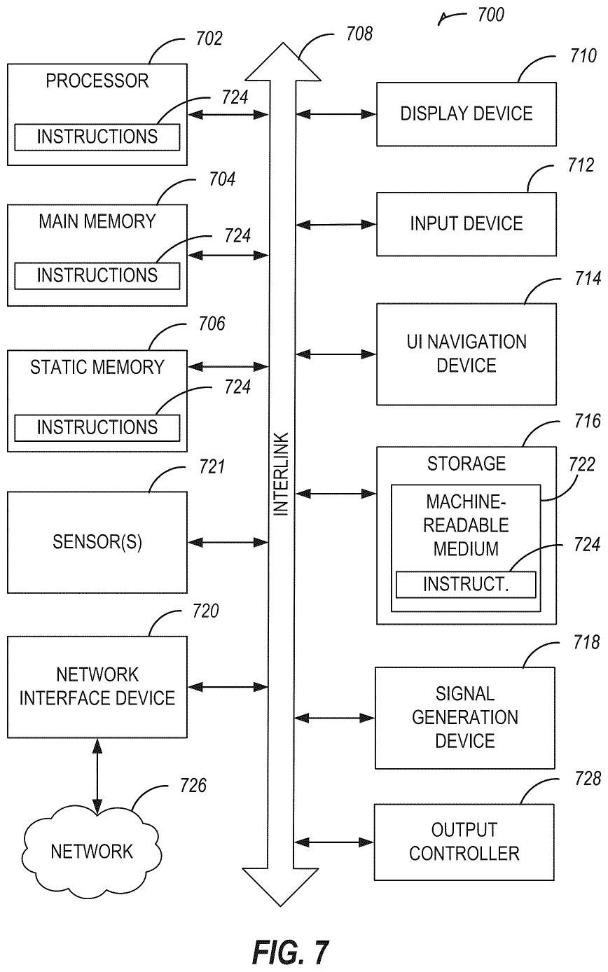

FIG. 4 illustrates a flowchart showing a technique 400 for generating a passkey affiliation score, according to various examples. In an example, operations of the technique 400 may be performed by processing circuitry, for example, by executing instructions stored in memory. The processing circuitry may include a processor, a system on a chip, or other circuitry (e.g., wiring). For example, the technique 400 may be performed by processing circuitry of a device (or one or more hardware or software components thereof), such as those illustrated or described with reference to FIG. 1 or 7.

The technique 400 includes an operation 402 to query, from an entity device, a user device for a passkey keychain. In some examples, the query in operation 402 may be initiated by the entity device when the user attempts to access a service or resource requiring authentication. The query may be transmitted over a secure network connection. The query may include additional information such as the an identifier of a requesting entity or a specific service being accessed. In some examples, the query may specify a desired level of assurance or a specific type of passkey that is to be used for authentication. The entity device may use this information to tailor the authentication process or ensure that authentication meets the requested security requirements. In some examples, the entity device may initiate the query in operation 402 upon receiving a request.

In some examples, querying the user device includes querying the user device in response to receiving a request for a resource from a user device at an entity device. In these examples, the technique 400 may include granting access to the resource based on the passkey affiliation score. For example, a user with a high passkey affiliation score (e.g., above a threshold) may be granted immediate access to their online bank account without any additional authentication steps, while a user with a low passkey affiliation score (e.g., below a threshold) may be denied access to certain features or resources, or be required to go through a more rigorous authentication process.

In some examples, the query may be implemented using a communication protocol, such as HTTPS, WebSocket, or other secure messaging system. The query may be formatted according to a standardized protocol or a custom schema agreed upon by the entity device or the user device. In some embodiments, the query may be accompanied by a digital signature or other cryptographic proof to ensure its authenticity or prevent unauthorized modifications. The entity device may include a nonce or other challenge in the query to prevent replay attacks or ensure that the response is fresh.

In some examples, the user device, upon receiving the query, may prompt the user to grant permission for sharing the passkey keychain. The prompt may display information about the requesting entity or the purpose of the authentication request, allowing the user to make an informed decision. The user may interact with the prompt through an input mechanism, such as a touchscreen, a button press, click, key entry, biometric authentication, or the like.

The user may have a pre-configured setting to automatically share the keychain with certain trusted entities. This setting may be based on user preference or a specified trustworthiness of the entity. The user device may maintain a list of blocked or untrusted entities, preventing access to the passkey keychain.

The technique 400 includes an operation 404 to receive, at the entity device, the passkey keychain from the user device, the passkey keychain including at least one passkey between a user-affiliated entity or the user device. In some examples, the passkey keychain received in operation 404 may be securely transmitted from the user device to the entity device using an encryption or other cryptographic technique. The specific encryption or cryptographic technique used may vary depending on an implementation or security requirement. For example, the passkey may be encrypted using a symmetric key shared between the user device and the entity device, or the passkey may be encrypted using the entity device's public key or decrypted using its corresponding private key. In some examples, the passkey keychain received in operation 404 may contain a passkey that includes a public cryptographic key associated with the user device and the user-affiliated entity.

In some examples, the keychain may contain a list of affiliated entities, each for example identified by a unique identifier such as a domain name or a service ID. The unique identifier may be a human-readable string or a machine-readable code that uniquely identifies the affiliated entity. In other examples, the keychain may include metadata associated with a passkey, such as a date of creation, a last used timestamp, a type of passkey, or the like. The metadata may provide additional context or information about the passkey relationship, which may be used by the entity device to assess the strength or trustworthiness of the relationship. The passkey keychain may be stored in a secure manner on the entity device, such as in an encrypted database or a protected memory location, to prevent unauthorized access or modification. In some examples, in response to determining that the passkey keychain includes a second passkey associated with the user-affiliated entity, the passkey affiliation score may be reduced. For example, when the passkey keychain includes multiple passkeys associated with the same user-affiliated entity, this may result in a reduction in the passkey affiliation score, potentially indicating a less exclusive relationship.

The technique 400 includes an operation 406 to send a verification request to the user-affiliated entity, the verification request including an identity of a user associated with the user device or the at least one passkey. The selection of the affiliated entity may be based on one or more factors, such as a reputation of the user-affiliated entity, a strength of a relationship between the user-affiliated entity and the user, a specific type of verification requested, or the like. The request may include a user identifier, such as an email address, a unique user ID, a phone number, or the like. The request may include relevant passkey information, such as a public key, creation date, or the like.

In some examples, the request may specify a type of verification requested, such as confirming the existence of the passkey relationship or requesting an additional user attribute. For example, the request may ask the user-affiliated entity to verify that the user has successfully authenticated with the passkey within a certain timeframe. In an example, the request may seek additional information about the user, such as their account status, transaction history, or demographic data. The specific type or level of detail of the requested information may depend on the context of the authentication request or a policy of the requestor.

In some examples, the verification request may be transmitted to the user-affiliated entity using a secure communication channel, such as a secure network protocol, API, or dedicated messaging system. The request may be formatted according to a standardized protocol or a custom schema agreed upon by the entity device or the affiliated entity. In some embodiments, the verification request may be accompanied by a digital signature or other cryptographic proof to ensure its authenticity or prevent unauthorized modification.

In some embodiments, the user-affiliated entity, upon receiving the verification request, may perform a check or validation to respond to the request. The verification process may include accessing an internal record, comparing the provided passkey information with stored data, interacting with the user to confirm the user identity, or the like. The user-affiliated entity may generate a verification response, which may include a confirmation or denial of the validity of the passkey, or may provide more detailed information about the user as requested.

The technique 400 includes an operation 408 to receive a verification response from the user-affiliated entity indicating whether the identity or the at least one passkey are valid or match. In some examples, the verification response received in operation 408 may include a confirmation or denial of the validity of the passkey. The verification response may be digitally signed or encrypted by the user-affiliated entity to ensure its authenticity or prevent tampering. The entity device may employ a cryptographic technique to validate the signature or decrypt the response, ensuring that the response originated from the user-affiliated entity. In some examples, the verification response may indicate a success of an authentication attempt or a failure of an authentication attempt using the passkey.

The verification response may provide details about a user identity, attributes, or their activity history with the affiliated entity. For example, the response may include additional information about the user, such as an account status, a transaction history, or other relevant attribute. In an example, a financial institution may provide information about an account existence, credit score, a recent transaction, etc. In an example, a social media platform may share data about a profile, connections, activity history, or the like. The entity device may use this additional information to further refine the passkey affiliation score or determine trustworthiness of the user device. The specific attributes included in the verification response may depend on the nature of the affiliated entity or the context of the authentication request. In some examples, the entity device may verify the authenticity or integrity of the verification response using a cryptographic signature or another security mechanism.

In some examples, the verification response includes at least one user parameter associated with the at least one passkey, and generating the passkey affiliation score includes using the at least one parameter to authenticate the user device. For example, the at least one user parameter associated with the at least one passkey may include biometric data (e.g., fingerprint data, facial recognition data, etc.), a security question, other identifying information linked to the user account with the affiliated entity, or the like. The entity may leverage these user parameters during the passkey affiliation score generation process to authenticate the user device.

The technique 400 includes an operation 410 to, in response to receiving the verification response, generate a passkey affiliation score for the user device. In some examples, the passkey affiliation score may be a numerical value or a categorical rating that reflects a level of trust or confidence in the identity of the user device. The score may be generated based on one or more various factors, such as a number of verified passkeys, a strength of a passkey relationships, a tenure of the passkey relationships, additional information provided in the verification response, or the like. In some examples, the score may be generated by assigning weights to different factors or employing a machine learning algorithm to analyze complex patterns in the data. The generated passkey affiliation score may be stored locally on the entity device or transmitted to a central server for further processing or analysis.

In some examples, when generating the passkey affiliation score, the entity device may use a relationship between the entity controlling the device (e.g., a financial institution) and the user-affiliated entity (e.g., a particular brand). In an example, the entity device may evaluate and weight a plurality of criteria associated with the affiliated entity, such as the reputation or security practices of the affiliated entity. In some examples, generating the passkey affiliation score may include using at least one of a frequency of an interaction between the user device and the user-affiliated entity, a type of interaction between the user device and the user-affiliated entity, or a length of time during which the user-affiliated entity has been affiliated with the user device. For example, the entity device may access a reputation database or security rating service to assess the trustworthiness of the affiliated entity. In this example, a higher reputation or stronger security practices may contribute to a higher passkey affiliation score.

In an example, when the user device frequently interacts with the user-affiliated entity a stronger relationship may be indicated, resulting in a higher passkey affiliation score. For example, a user who regularly logs into their bank account from their smartphone may have a higher score than someone who rarely does so. In an example, the nature of the interactions between the user device and the affiliated entity may influence the passkey affiliation score. For example, high-value or sensitive interactions, such as financial transactions or accessing personal data, may contribute more to the passkey affiliation score than simple browsing or content consumption. In an example, a longer history of affiliation between the user device and the user-affiliated entity may indicate a more established and trustworthy relationship, resulting in a higher score. For example, a user who has been a customer of a financial institution for many years may be assigned a higher passkey affiliation score than a new customer.

In other examples, the entity device may use the passkey affiliation score to make a decision about granting access to services, setting a transaction limit, offering a personalized experience to the user, or the like. For example, a high passkey affiliation score (e.g., above a threshold) may result in streamlined access to a premium feature or higher transaction limit, while a low passkey affiliation score (e.g., below a threshold) may trigger an additional security check or restriction. The thresholds described herein may include a single threshold (e.g., a pass/fail score) or may include more than one threshold (e.g., two thresholds such that three ranges occur, a low range, a middle range, and a high range, which may be treated separately).

In some examples, the passkey affiliation score may be used to personalize the user experience by tailoring a recommendation, offer, or other content based on the inferred level of trust. The score may be combined with other risk assessment factors, such as transaction history or device reputation, to create a more comprehensive evaluation of the user's trustworthiness. In some examples, based on a high passkey affiliation score, the entity may device to generate a new passkey directly with the user device.

In some examples, the passkey affiliation score may be based on external data relating to at least one of the user-affiliated entity, the user, or the user device. For example, the passkey affiliation score may be dynamically updated based on external data sources, such as a security threat intelligence feed or information about user behavior on other platforms. In some examples, when the user-affiliated entity is flagged as potentially compromised or associated with suspicious activity, the passkey affiliation score may be temporarily lowered, triggering additional security measures or denying access to a service or resource.

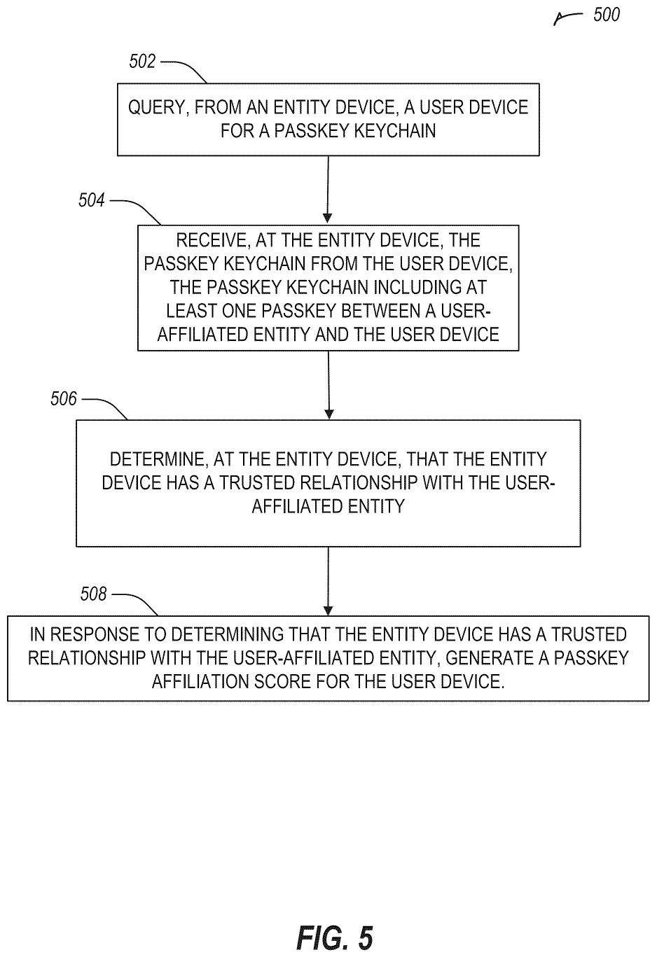

FIG. 5 illustrates a flowchart showing a technique for determining that an entity device has a trusted relationship with a user-affiliated entity to generate a passkey affiliation score, according to various examples.

In some examples, operations of the technique 500 may be performed by processing circuitry, for example, by executing instructions stored in memory. The processing circuitry may include a processor, a system on a chip, or other circuitry (e.g., wiring). For example, the technique 500 may be performed by processing circuitry of a device (or one or more hardware or software components thereof), such as those illustrated or described with reference to FIG. 1 or 7.

The technique 500 includes an operation 502 to query, from an entity device, a user device for a passkey keychain. The query may be initiated in response to a request for access to a service or resource provided by the entity. In some examples, the query may be transmitted securely over a network using an encrypted communication protocol. In other examples, the query may include a challenge or nonce to ensure the freshness and authenticity of the response from the user device. The user device, upon receiving the query, may prompt the user to grant permission for sharing the passkey keychain. The user may be presented with information about the requesting entity and the purpose of the request before making a decision.

The technique 500 includes an operation 504 to receive, at the entity device, the passkey keychain from the user device, the passkey keychain including at least one passkey between a user-affiliated entity and the user device. The passkey keychain may be transmitted securely from the user device to the entity device using encryption or another cryptographic technique. In some examples, the keychain may contain a list of affiliated entities, each identified by a unique identifier such as a domain name or a service ID. The keychain may include metadata associated with a passkey, such as the date of creation, the last used timestamp, or the type of passkey. The entity device may validate the authenticity and integrity of the received passkey keychain using a digital signature or another security mechanism.

The technique 500 includes an operation 506 to determine, at the entity device, that the entity device has a trusted relationship with the user-affiliated entity. Operation 506 may include identifying a shared passkey between the entity device and the user-affiliated entity, determining a reputation or credibility of the user-affiliated entity, identifying a historical interaction between the entity device and the user-affiliated entity, or the like. In some examples, the entity device may maintain a list of trusted entities or rely on a trust framework or a reputation system to assess the trustworthiness of the user-affiliated entity.

The technique 500 includes an operation 508 to, in response to determining that the entity device has a trusted relationship with the user-affiliated entity, generate a passkey affiliation score for the user device.

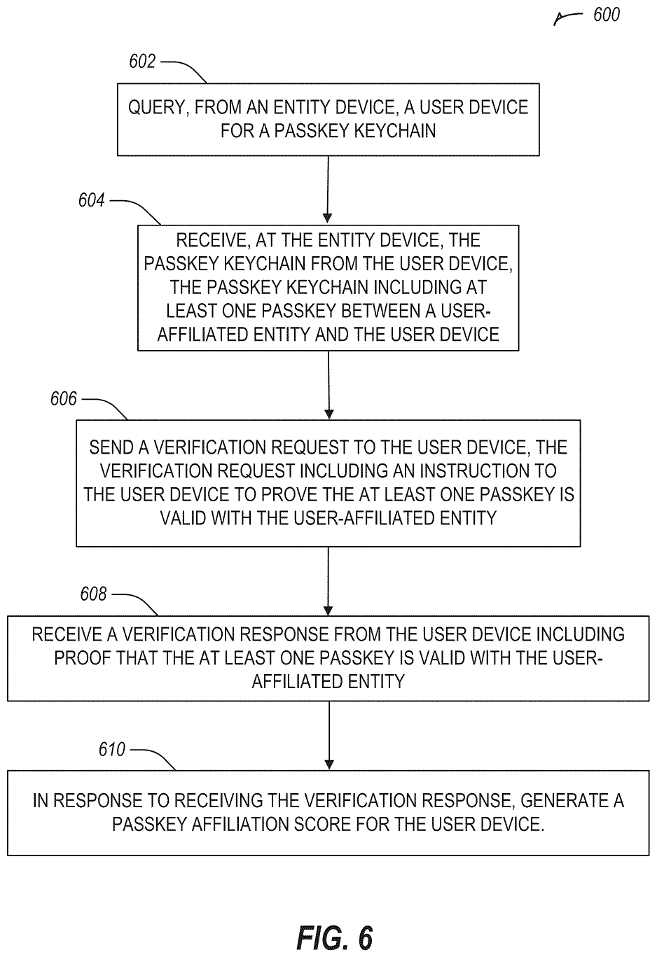

FIG. 6 illustrates a flowchart showing a technique for determining that an entity device has at least one passkey that is valid with a user-affiliated entity to generate a passkey affiliation score, according to various examples.

The technique 600 includes an operation 602 to query, from an entity device, a user device for a passkey keychain. In some examples, the query in operation 602 may be initiated by the entity device when a user attempts to access a service or resource requiring authentication at the entity device. The query may be transmitted over a secure network connection.

The technique 600 includes an operation 604 to receive, at the entity device, the passkey keychain from the user device, the passkey keychain including at least one passkey between a user-affiliated entity and the user device. In some examples, the passkey keychain received in operation 604 may be securely transmitted from the user device to the entity device using an encryption or other cryptographic key technique. In other examples, the at least one passkey may include a public cryptographic key associated with the user device and the user-affiliated entity.

The technique 600 includes an operation 606 to send a verification request to the user device, the verification request including an instruction to the user device to prove the at least one passkey is valid with the user-affiliated entity.

The technique 600 includes an operation 608 to receive a verification response from the user device including proof that the at least one passkey is valid with the user-affiliated entity. In some examples, the verification response may indicate a success or failure of an authentication attempt. The verification response may include information relating to at least one of a user identity, a user attribute, a history of user activity with the user-affiliated entity, or the like. In some examples, the verification response may include at least one user parameter associated with the at least one passkey.

The technique 600 includes an operation 610 to, in response to receiving the verification response, generate a passkey affiliation score for the user device. In some examples, generating the passkey affiliation score may include using the at least one parameter to authenticate the user device. Generating the passkey affiliation score may include generating the passkey affiliation score based on a relationship between an entity controlling the entity device and the user-affiliated entity. In an example, generating the passkey affiliation score may further include evaluating a plurality of criteria associated with the user-affiliated entity and weighting the plurality of criteria based on the evaluation. In other examples, generating the passkey affiliation score may include using at least one of a frequency of interaction between the user device and the user-affiliated entity, a type of interaction between the user device and the user-affiliated entity, or a length of time during which the user-affiliated entity has been affiliated with the user device.

In some examples, the passkey affiliation score may be updated based on external data relating to at least one of the user-affiliated entity, the user, or the user device. The passkey affiliation score may be used to determine a level of service to provide to the user device and grant access to a resource based on the passkey affiliation score. In an example, a passkey may be generated between the entity device and the user device based on the passkey affiliation score.

FIG. 7 illustrates generally an example of a block diagram of a machine upon which any one or more of the techniques discussed herein may perform, in accordance with some embodiments. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) or a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time or reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 or a static memory 706, some or all of which may communicate with each other via an interlink (e.g., bus) 708. The machine 700 may further include a display unit 710, an alphanumeric input device 712 (e.g., a keyboard), or a user interface (UI) navigation device 714 (e.g., a mouse). In an example, the display unit 810, alphanumeric input device 712 or UI navigation device 714 may be a touch screen display. The machine 700 may additionally include a storage device (e.g., drive unit) 716, a signal generation device 718 (e.g., a speaker), a network interface device 720, or one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches or servers) configured to store the one or more instructions 724.

The term “machine readable medium” may include any medium that is capable of storing, encoding, or carrying instructions for execution by the machine 700 or that cause the machine 700 to perform any one or more of the techniques of the present disclosure, or that is capable of storing, encoding or carrying data structures used by or associated with such instructions. Non-limiting machine-readable medium examples may include solid-state memories, or optical or magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) or flash memory devices; magnetic disks, such as internal hard disks or removable disks; magneto-optical disks; or CD-ROM or DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), networks, or wireless data networks (e.g., Institute of Electrical or Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, or includes digital or analog communications signals or other intangible medium to facilitate communication of such software.

The following, non-limiting examples, detail certain aspects of the present subject matter to solve the challenges or provide the benefits discussed herein, among others.

Example 1 is a method comprising: querying, from an entity device, a user device for a passkey keychain; receiving, at the entity device, the passkey keychain from the user device, the passkey keychain including at least one passkey between a user-affiliated entity and the user device; sending a verification request to the user-affiliated entity, the verification request including an identity of a user associated with the user device and the at least one passkey; receiving a verification response from the user-affiliated entity indicating whether the identity and the at least one passkey are valid and match; and in response to receiving the verification response, generating a passkey affiliation score for the user device.

In Example 2, the subject matter of Example 1 includes, wherein generating the passkey affiliation score further comprises, in response to determining the passkey keychain includes a second passkey associated with the user-affiliated entity, reducing the passkey affiliation score.

In Example 3, the subject matter of Examples 1-2 includes, wherein the at least one passkey includes a public cryptographic key associated with the user device and the user-affiliated entity.

In Example 4, the subject matter of Examples 1-3 includes, wherein querying the user device includes querying the user device in response to receiving a request for a resource from a user device at the entity device; and further comprising and granting access to the resource based on the passkey affiliation score.

In Example 5, the subject matter of Examples 1-4 includes, generating a passkey between the entity device and the user device based on the passkey affiliation score.

In Example 6, the subject matter of Examples 1-5 includes, wherein the verification response includes at least one user parameter associated with the at least one passkey, and wherein generating the passkey affiliation score includes using the at least one user parameter to authenticate the user device.

In Example 7, the subject matter of Examples 1-6 includes, wherein generating the passkey affiliation score includes generating the passkey affiliation score based on a relationship between an entity controlling the entity device and the user-affiliated entity.

In Example 8, the subject matter of Examples 1-7 includes, wherein generating the passkey affiliation score includes: evaluating a plurality of criteria associated with the user-affiliated entity; and weighting the plurality of criteria based on the evaluation.

In Example 9, the subject matter of Examples 1-8 includes, wherein the verification response indicates a success of an authentication attempt or a failure of an authentication attempt.

In Example 10, the subject matter of Examples 1-9 includes, wherein the verification response includes information relating to at least one of a user identity, a user attribute, or a history of user activity with the user-affiliated entity.

In Example 11, the subject matter of Examples 1-10 includes, wherein generating the passkey affiliation score includes using at least one of a frequency of an interaction between the user device and the user-affiliated entity, a type of interaction between the user device and the user-affiliated entity, or a length of time during which the user-affiliated entity has been affiliated with the user device.

In Example 12, the subject matter of Examples 1 -11 includes, updating the passkey affiliation score based on external data relating to at least one of the user-affiliated entity, the user, or the user device.

Example 13 is at least one non-transitory machine readable medium including instructions, which when executed by processing circuitry, cause the processing circuitry to perform operations to: query, from an entity device, a user device for a passkey keychain; receive, at the entity device, the passkey keychain from the user device, the passkey keychain including at least one passkey between a user-affiliated entity and the user device; send a verification request to the user-affiliated entity, the verification request including an identity of a user associated with the user device and the at least one passkey; receive a verification response from the user-affiliated entity indicating whether the identity and the at least one passkey are valid and match; and generate, in response to receiving the verification response, a passkey affiliation score for the user device.

In Example 14, the subject matter of Example 13 includes, wherein the at least one passkey includes a public cryptographic key associated with the user device and the user-affiliated entity.

In Example 15, the subject matter of Examples 13-14 includes, wherein the verification response includes at least one user parameter associated with the at least one passkey, and wherein generating the passkey affiliation score includes using the at least one user parameter to authenticate the user device.

In Example 16, the subject matter of Examples 13-15 includes, wherein the verification response indicates a success of an authentication attempt or a failure of an authentication attempt.

In Example 17, the subject matter of Examples 13-16 includes, wherein the verification response includes information relating to at least one of a user identity, a user attribute, or a history of user activity with the user-affiliated entity.

Example 18 is a system comprising: processing circuitry; and memory, including instructions, which when executed by the processing circuitry, cause the processing circuitry to:
query, from an entity device, a user device for a passkey keychain; receive, at the entity device, the passkey keychain from the user device, the passkey keychain including at least one passkey between a user-affiliated entity and the user device; send a verification request to the user-affiliated entity, the verification request including an identity of a user associated with the user device and the at least one passkey; receive a verification response from the user-affiliated entity indicating whether the identity and the at least one passkey are valid and match; and generate, in response to receiving the verification response, a passkey affiliation score for the user device.

In Example 19, the subject matter of Example 18 includes, wherein the at least one passkey includes a public cryptographic key associated with the user device and the user-affiliated entity.

In Example 20, the subject matter of Examples 18-19 includes, wherein the verification response includes at least one user parameter associated with the at least one passkey, and wherein generating the passkey affiliation score includes using the at least one user parameter to authenticate the user device.

Example 21 is a method comprising: querying, from an entity device, a user device for a passkey keychain; receiving, at the entity device, the passkey keychain from the user device, the passkey keychain including at least one passkey between a user-affiliated entity and the user device; determining, at the entity device, that the entity device has a trusted relationship with the user-affiliated entity; and in response to determining that the entity device has a trusted relationship with the user-affiliated entity, generating a passkey affiliation score for the user device.

In Example 22, the subject matter of Example 21 includes, wherein generating the passkey affiliation score for the user device includes identifying a plurality of passkeys in the passkey keychain, each passkey associated with a corresponding user-affiliated entity of a plurality of user-affiliated entities, and determining whether the entity device has a trusted relationship with at least one of the plurality of user-affiliated entities associated with the passkey.

In Example 23, the subject matter of Examples 21-22 includes, determining whether to authenticate the user device based on the passkey affiliation score by comparing the passkey affiliation score to a specified threshold, and wherein the user device is authenticated when the passkey affiliation score meets or exceeds the specified threshold.

Example 24 is a method comprising: querying, from an entity device, a user device for a passkey keychain; receiving, at the entity device, the passkey keychain from the user device, the passkey keychain including at least one passkey between a user-affiliated entity and the user device; sending a verification request to the user device, the verification request including an instruction to the user device to prove the at least one passkey is valid with the user-affiliated entity; receiving a verification response from the user device including proof that the at least one passkey is valid with the user-affiliated entity; and in response to receiving the verification response, generating a passkey affiliation score for the user device.

In Example 25, the subject matter of Example 24 includes, using the passkey affiliation score to determine a level of service to provide to the user device.

In Example 26, the subject matter of Examples 24-25 includes, wherein the verification response indicates a success of an authentication attempt or a failure of an authentication attempt.

In Example 27, the subject matter of Examples 24-26 includes, wherein generating the passkey affiliation score includes generating the passkey affiliation score based on a relationship between an entity controlling the entity device or the user-affiliated entity.

Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement of any of Examples 1-27.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks or digital video disks), magnetic cassettes, memory cards or sticks, random access memories (RAMs), read only memories (ROMs), or the like.

What is claimed is:

1. A method comprising:
querying, from an entity device, a user device for a passkey keychain;
receiving, at the entity device, the passkey keychain from the user device, the passkey keychain including at least one passkey between a user-affiliated entity and the user device;
sending a verification request to the user-affiliated entity, the verification request including an identity of a user associated with the user device and the at least one passkey;
receiving a verification response from the user-affiliated entity indicating whether the identity and the at least one passkey are valid and match; and
in response to receiving the verification response, generating a passkey affiliation score for the user device.

2. The method of claim 1, wherein generating the passkey affiliation score further comprises, in response to determining the passkey keychain includes a second passkey associated with the user-affiliated entity, reducing the passkey affiliation score.

3. The method of claim 1, wherein the at least one passkey includes a public cryptographic key associated with the user device and the user-affiliated entity.

4. The method of claim 1, wherein querying the user device includes querying the user device in response to receiving a request for a resource from a user device at the entity device; and further comprising and granting access to the resource based on the passkey affiliation score.

5. The method of claim 1, further comprising, generating a passkey between the entity device and the user device based on the passkey affiliation score.

6. The method of claim 1, wherein the verification response includes at least one user parameter associated with the at least one passkey, and wherein generating the passkey affiliation score includes using the at least one user parameter to authenticate the user device.

7. The method of claim 1, wherein generating the passkey affiliation score includes generating the passkey affiliation score based on a relationship between an entity controlling the entity device and the user-affiliated entity.

8. The method of claim 1, wherein generating the passkey affiliation score includes:
evaluating a plurality of criteria associated with the user-affiliated entity; and
weighting the plurality of criteria based on the evaluation.

9. The method of claim 1, wherein the verification response indicates a success of an authentication attempt or a failure of an authentication attempt.

10. The method of claim 1, wherein the verification response includes information relating to at least one of a user identity, a user attribute, or a history of user activity with the user-affiliated entity.

11. The method of claim 1, wherein generating the passkey affiliation score includes using at least one of a frequency of an interaction between the user device and the user-affiliated entity, a type of interaction between the user device and the user-affiliated entity, or a length of time during which the user-affiliated entity has been affiliated with the user device.

12. The method of claim 1, further comprising updating the passkey affiliation score based on external data relating to at least one of the user-affiliated entity, the user, or the user device.

13. At least one non-transitory machine readable medium including instructions, which when executed by processing circuitry, cause the processing circuitry to perform operations to:
query, from an entity device, a user device for a passkey keychain;
receive, at the entity device, the passkey keychain from the user device, the passkey keychain including at least one passkey between a user-affiliated entity and the user device;
send a verification request to the user-affiliated entity, the verification request including an identity of a user associated with the user device and the at least one passkey;
receive a verification response from the user-affiliated entity indicating whether the identity and the at least one passkey are valid and match; and
generate, in response to receiving the verification response, a passkey affiliation score for the user device.

14. The at least one non-transitory machine readable medium of claim 13, wherein the at least one passkey includes a public cryptographic key associated with the user device and the user-affiliated entity.

15. The at least one non-transitory machine readable medium of claim 13, wherein the verification response includes at least one user parameter associated with the at least one passkey, and wherein generating the passkey affiliation score includes using the at least one user parameter to authenticate the user device.

16. The at least one non-transitory machine readable medium of claim 13, wherein the verification response indicates a success of an authentication attempt or a failure of an authentication attempt.

17. The at least one non-transitory machine readable medium of claim 13, wherein the verification response includes information relating to at least one of a user identity, a user attribute, or a history of user activity with the user-affiliated entity.

18. A system comprising:
processing circuitry; and
memory, including instructions, which when executed by the processing circuitry, cause the processing circuitry to:
query, from an entity device, a user device for a passkey keychain;
receive, at the entity device, the passkey keychain from the user device, the passkey keychain including at least one passkey between a user-affiliated entity and the user device;
send a verification request to the user-affiliated entity, the verification request including an identity of a user associated with the user device and the at least one passkey;
receive a verification response from the user-affiliated entity indicating whether the identity and the at least one passkey are valid and match; and
generate, in response to receiving the verification response, a passkey affiliation score for the user device.

19. The system of claim 18, wherein the at least one passkey includes a public cryptographic key associated with the user device and the user-affiliated entity.

20. The system of claim 18, wherein the verification response includes at least one user parameter associated with the at least one passkey, and wherein generating the passkey affiliation score includes using the at least one user parameter to authenticate the user device.
